(19) United States
(12) Patent Application Publication
(10) Pub. No.: US 2004/0164840 A1
(43) Pub. Date: Aug. 26, 2004

(54) Extraordinary hall effect sensors and arrays

(75) Inventors: Gang Xiao, Barrington, RI (US); Guo-Xing Miao, Yorktown Heights, NY (US)

Correspondence Address: HARRINGTON & SMITH, LLP, 4 RESEARCH DRIVE, SHELTON, CT, 06484-6212, US

(73) Assignee: Brown University Research Foundation

(21) Appl. No.: 10/371,321

(22) Filed: Feb. 21, 2003

(51) Int. Cl. B32B 9/00

(52) U.S. Cl. 338/32 H; 428/692

(57) ABSTRACT

An EHE magnetic sensor has an alloy of the form R_{y}[MₓN₁₀₀₋ₓ]_{100-y}, M being Fe, Co, Ni, or magnetic alloys that contain Fe, Co or Ni. N is from the fifth or sixth period of the periodic table. If present, R is a rare earth element. In one embodiment, the alloy exhibits a Temperature Coefficient ≦0.003 K⁻¹ in the room temperature region. Various geometric shapes of sensors are presented including one and two-dimensional arrays of sensors for measuring spatial magnetic fields. Vias (98, 100, 102, 104) defined by a substrate (92) onto which an alloy layer (106) is disposed are filled with a conductive material in certain embodiments of arrays. Methods are disclosed for making a sensor, for designing a sensor at a thickness, for determining maximum acceptable current through a sensor, for reducing Joule heating of a sensor, and for making an array of sensors.

### TECHNICAL FIELD

These teachings relate generally to sensors and arrays of sensors based on Extraordinary Hall Effect (EHE) for measuring magnetic field. More particularly, this invention relates to metallic alloys for EHE sensors, disposition and thickness of those alloys, and methods of making and testing those alloys.

### BACKGROUND

In a magnetic field, a conductor exhibits an electrical property called Hall effect. A Hall sensor can be constructed to measure magnetic field by measuring the induced voltage in the conductor. There are two types of Hall effect, the ordinary Hall effect (OHE) and the extraordinary Hall effect (EHE). OHE can be found in any metals or doped semiconductors. It is caused by the Lorentz force on electrons due to a magnetic field. EHE only exists in ferromagnetic metals, resulting from spin-orbit scattering of electrons off of disorders (impurities, grain boundaries, interfaces, etc.). Therefore, the physics behind EHE is entirely different from that behind OHE.

FIG. 1 depicts a generic embodiment of a Hall effect sensor illustrating the principal of operation. A Hall sensor is typically a conducting slab with length (l), width (w), and thickness (t). An excitation electrical current I is sent along the length dimension. The magnetic field H to be sensed is applied perpendicular to the slab. Under the Lorentz force due the magnetic field, the current will be bent towards the transverse direction and a voltage builds up in that direction, depicted in FIG. 1 as V₋ and V₊, until equilibrium is reached. This voltage is called the Hall voltage, which is proportional to the applied magnetic field H. In general, EHE yields a Hall voltage much larger than the ordinary Hall effect.

Commercial Hall sensors operate on ordinary Hall effects and use mostly semiconductors. It is believed that sensors based on extraordinary Hall effect materials offer better performance than ordinary Hall sensors for at least the following reasons.

For conductors with similar carrier densities, EHE is larger than OHE by a few orders of magnitude, rendering the EHE sensors potentially much more sensitive.

Sensors based on EHE are metallic-only, having lower resistance and therefore consuming less power than typical OHE sensors. Low power consumption is becoming increasingly important for modern electronic devices. The resistivity of semiconductor Hall sensors is typically larger than EHE sensors by 10²-10¹¹.

Giant magnetoresistance (GMR) effect or magnetic tunneling junction (MTJ) sensors exhibit linear correlation between voltage and magnetic field only in their narrow field operating ranges. EHE sensors can be made to exhibit a similarly linear response over a large range of magnetic field and at room temperature.

Semiconductor Hall sensors are relatively expensive to fabricate. GMR and MTJ sensors comprise complex multilayer structures and are similarly expensive. Effective EHE sensors can be manufactured simply and cost effectively by means of a single-film deposition process.

Most commercial Hall sensors have an upper frequency limit of hundreds of kHz. Metallic EHE sensors have much wider frequency response range than semiconductor Hall sensors. EHE sensors enjoy an upper limit of tens of GHz.

In semiconductor Hall sensors, in addition to other types of noises, there exists a voltage noise due to carrier generation or recombination (G-R). The frequency dependence of the G-R noise exhibits a Lorentzian spectrum. G-R noise does not exist in metal-based EHE sensors, offering the potential for increased sensitivity.

### Applications of EHE Sensors and Arrays of EHE Sensors

Hall sensors can be deployed individually to measure magnetic activity at a single point, or in a one-dimensional (x axis) or two-dimensional (x-y axis) array to measure activity at numerous points of interest simultaneously. In general, EHE sensors and their arrays can be used in any application where an unknown magnetic field, DC, AC, or RF, needs to be measured. Magnetic fields can be emitted by many different kinds of sources—astronomical bodies, magnetic materials-(solids, liquids, gases, and plasmas), electrical currents, biological materials or organs, to name a few.

EHE sensors and arrays of EHE sensors can be used to image magnetic fields on the surface (front-side or back-side) of a semiconductor integrated circuit (IC). From the magnetic field image, one can derive the electrical current distribution of the microstructures embedded inside the IC. This technique can be used for fault isolation and failure analysis of ICs, or in-line inspection of the manufacturing ICs. It should be noted that such an application is a non-destructive analysis that can potentially be deployed to monitor every IC when fabricated, and should be fully compatible with the reduced trace line widths (0.09 micron copper) in the next generation of IC's.

EHE sensors and arrays of EHE sensors can be used to detect counterfeit currency. Many official currencies are partially printed using magnetic inks, which generate magnetic images on the surface of currency. By scanning the surface of a currency bill and displaying the magnetic images on a scanner, the authenticity of the bill can be checked.

EHE sensors and arrays of EHE sensors can be used as biomagnetic sensor arrays, analytical devices for detecting biologically active materials. To enable detection, magnetic entities are engineered to attach to specific biological hosts. Typically, a nanoscale particle or wire is coated with an active material like gold or copper. The engineered particles serve as magnetic tags, allowing physicians and scientists to track the biological host associated with a particular version of the tag. By detecting the magnetic moment and the motion of the tags, scientists can determine the type of biological host involved and pinpoint their locations.

EHE sensors and arrays of EHE sensors can be used to image the domain structures of future recording media, even as bit resolutions approach the superparamagnetic limit. They can also be used by researchers to study micromagnetics, biomagnetism, and flux line structure in superconductors. EHE sensors and arrays of them can be used in many instruments and devices, such as read/write heads for data storage devices, electronic compasses, position or angle detectors and encoders, non-contact current sensors, non-destructive evaluations, magnetic random access memories, virtual reality interfaces, animation instruments, mine detectors, military sensors, vibration and velocity detectors, credit card readers, magnetic domain pattern imagers, etc.

The above is only a partial list of potential EHE applications that makes clear that no single EHE sensor or array of them is appropriate for all uses. The present invention is directed to disclosing certain EHE devices that overcome some of the above-listed disadvantages of semiconductor Hall effect sensors. It is also directed to methods of discovering which EHE sensor is most effective for a given application. The present invention is further directed to methods of comparing different alloy compositions and thicknesses used in an EHE sensor for optimization of a particular characteristic that may be desired in an EHE sensor for a particular application. Additionally, the present invention explores numerous geometric layouts for EHE sensors and arrays of EHE sensors for further optimization.

### SUMMARY OF THE PREFERRED EMBODIMENTS

The foregoing and other problems are overcome, and other advantages are realized, in accordance with the presently preferred embodiments of these teachings. One preferred embodiment of an EHE magnetic sensor according to the present invention comprises an alloy of the form R_{y}[MₓN₁₀₀₋ₓ]_{100-y}; wherein 0≦x≦100, 0.00<y≦20.00, and M is selected from the group consisting of Fe, Co, Ni, Fe_{z}Co_{100-z} wherein 0<z<100, and all magnetic alloys containing Fe, Co or Ni.

Another embodiment of the present invention is an array of n EHE magnetic sensors, n being an integer >1. The array comprises an alloy of the form R_{y}[MₓN₁₀₀₋ₓ]_{100-y}, wherein 0≦x≦100, 0.00<y≦20.00, and M is selected from the group consisting of Fe, Co, Ni, Fe_{z}Co₁₀₀₋₁ wherein 0<z<100, and all magnetic alloys containing Fe, Co or Ni. The alloy is formed into a Hall bar along which sense current is carried between points C1 and C2 located on the Hall bar, as shown, for example, at FIG. 18. The array further comprises a plurality of n voltage wires for measuring Hall voltage between the points H1ₙ and H2ₙ that are located along the n^{th} voltage wire, and a plurality of n field sensors defined by an intersection of the n^{th} voltage wire with the Hall bar.

In another preferred embodiment of the present invention, an EHE magnetic sensor comprises an alloy defining a thickness t of the form R_{y}[MₓN₁₀₀₋ₓ]_{100-y}, wherein 0≦x≦100, 0.00≦y≦20.00. M is selected from the group consisting of Fe, Co, Ni, Fe_{z}Co_{100-z}, and all magnetic transition elements, wherein 0<z<100. Furthermore, N is selected from the group consisting of Pt, Y, Zr, Nb, Mo, Tc, Ru, Rh, Pd, Hf, Ta, W, Re, Os, Ir, Au, In, Sn, Te, TI, Pb and Bi. The alloy according to this embodiment exhibits a temperature coefficient T.C. having an absolute value |T.C.|≦0.003 K⁻¹ at least in the temperature range 273 K and 350 K.

The present invention also includes a method of making an EHE sensor that includes: providing a substrate; preparing the substrate by cleaning it in a vacuum using an ion beam; selecting an alloy R_{y}[MₓN₁₀₀₋₁]_{100-y}, wherein 0≦x≦100, 0.00<y≦20.00, M is selected from the group consisting of Fe, Co, Ni, Fe_{z},Co_{100-z} wherein 0<z<100, and all magnetic alloys containing Fe, Co or Ni, wherein N is selected from the group consisting of Pt, Y, Zr, Nb, Mo, Tc, Ru, Rh, Pd, Hf, Ta, W, Re, Os, Ir, Au, In, Sn, Te, Tl, Pb and Bi, and wherein R is a rare earth element defined by one of the atomic numbers 58-71 if y>0.00; selecting a thickness t for the alloy; and disposing the alloy onto the substrate at the thickness t.

A method of making an array of EHE sensors includes providing a substrate that defines a first surface, an opposing second surface, and a plurality of vias penetrating from the first surface to the second surface; filling the vias with a conductive material; polishing at least the first surface of the substrate; and disposing an alloy that exhibits EHE onto the first surface. In this method, means such as photolithography may be used to define Hall bars and Hall voltage wires in the alloy.

The present invention also includes a method of designing an EHE sensor. This method includes selecting a first alloy R_{y}[MₓN₁₀₀₋ₓ]_{100-y} wherein 0≦x≦100, 0.00≦y≦20.00, M is selected from the group consisting of Fe, Co, Ni, Fe_{z}Co_{100-z} wherein 0<z<100, and all magnetic alloys containing Fe, Co or Ni, wherein N is selected from the group consisting of Pt, Y, Zr, Nb, Mo, Tc, Ru, Rh, Pd, Hf, Ta, W, Re, Os, Ir, Au, In, Sn, Te, Tl, Pb and Bi, and wherein R is a rare earth element defined by one of the atomic numbers 58-71 if y>0.00; preparing a first and a second sensor sample wherein the first alloy is deposited at a first and a second thickness, respectively; selecting a second alloy that varies from the first in either only the relative concentration of R or only the relative concentration of M; preparing a third and a fourth sensor sample wherein the second alloy is deposited at the first and the second thickness, respectively; and comparing electrical and magnetic properties of at least two of the sensor samples at a selected temperature.

The present invention further includes a method of determining a maximum acceptable sense current in an EHE sample sensor. This particular method includes selecting an alloy R_{y}[MₓN₁₀₀₋ₓ]_{100-y} wherein 0≦x≦100, 0.00≦y≦20.00, M is selected from the group consisting of Fe, Co, Ni, Fe_{z}CO_{100-z} wherein 0<z<100, and all magnetic alloys containing Fe, Co or Ni, wherein N is selected from the group consisting of Pt, Y, Zr, Nb, Mo, Tc, Ru, Rh, Pd, Hf, Ta, W, Re, Os, Ir, Au, In, Sn, Te, Tl, Pb and Bi, and wherein R is a rare earth element defined by one of the atomic numbers 58-71 if y>0.00; preparing a sample sensor by disposing the alloy on a substrate surface such that the alloy defines a thickness t; passing a first current through the alloy; measuring a first Hall voltage across the sample sensor at a first time; measuring a second Hall voltage across the sample sensor at a second time; passing a second current through the alloy; measuring a third Hall voltage across the sample sensor at a third time; measuring a fourth Hall voltage across the sample sensor at a fourth time; and evaluating voltage as a function of time for the first and the second currents.

The present invention also includes a method to reduce Joule heating on an EHE sensor, which is performed by converting a first electrical current defined by an arcuate sinusoidal wave function into a second electrical current defined by a non-arcuate wave function; and passing the second electrical current through the EHE sensor.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 is a depiction of a generic Hall Effect sensor of the prior art.

FIG. 2 is a top view showing the geometry of an EHE sensor according to the present invention.

FIG. 3 is a graph depicting EHE resistivity ρ_{xy} versus perpendicular magnetic field H, wherein H=4πMₛ is the saturation field for achieving maximum magnetization Mₛ.

FIG. 4 is a block diagram depiction of the sputtering system used to fabricate alloys for evaluation and use in EHE sensors according to the present invention.

FIG. 5 is a graph of EHE voltage (mV) versus magnetic field (T) for a given alloy sample, showing excellent sensing linearity at T=300 K.

FIG. 6 is a graph showing initial Hall slope dρ_{xy}/dH versus percent composition of a magnetic component in various alloys tested.

FIGS. 7A-7F are graphs showing Hall resistance versus magnetic field at various temperatures for alloy films of various compositions, each film being 300 Å thick.

FIGS. 8A and 8B are graphs showing initial Hall slope dρ_{xy}/dH versus temperature and resistivity versus temperature, respectively, for alloy films of various compositions, each film being 300 Å thick.

FIG. 9 is a graph showing initial Hall slope dρ_{xy}/dH versus thickness for a particular composition alloy film, with an inset graph showing resistivity versus thickness for the same film at T=300 K.

FIG. 10 is a graph showing the same data as FIG. 9, but for a different composition alloy film.

FIGS. 11A and 11B are graphs showing initial Hall slope dρ_{xy}/dH versus temperature and resistivity versus temperature, respectively, for a particular composition alloy at varying thickness.

FIGS. 12A and 12B are graphs showing the same data as FIGS. 11A-11B, but for a different composition alloy film.

FIGS. 13A and 13B are graphs showing initial Hall slope dρ_{xy}/dH versus temperature and resistivity versus temperature, respectively, for alloy films of various compositions, each film being 500 Å thick.

FIG. 14 is a graph showing extraordinary Hall voltage versus time for a particular film, 500 Å thick, at varying sense currents.

FIG. 15 depicts measurement (under no sense current) of noise at varying frequencies for a series of alloys having a particular composition but varying thickness (N.B.: logarithmic scale on both axes).

FIG. 16 depicts Johnson noise versus resistance for the alloy films tested in FIG. 15, wherein data is averaged around 1 kHz (above knee frequency of FIG. 15).

FIG. 17 depicts top views of various shapes of sense current pads, taken from the Hall Sensor Handbook, divided into rows and columns, wherein C1 and C2 are sense current pads or points, H1 with H2 and H3 with H4 are pairs of EHE voltage pads or points.

FIG. 18 is a top view representation of a one-dimensional array of EHE sensors, wherein the filled circle is the effective sensing area.

FIG. 19 is a top view representation of a two-dimensional array of EHE sensors, a portion of which is expanded for illustration, wherein the filled circle is the effective sensing area.

FIG. 20 is a perspective view of a two dimensional array of EHE sensors with defined Hall bars and Hall voltage wires.

FIG. 21 is an expanded portion of FIG. 20 detailing filled vias through the substrate.

FIG. 22 is a perspective view of a two dimensional array of EHE sensors without visible Hall bars or Hall voltage wires.

FIG. 23 is an expanded portion of FIG. 22 detailing filled vias through the substrate.

### DETAILED DESCRIPTION OF THE PREFERRED EMBODIMENTS

EHE sensors comprise an alloy disposed on a planar surface of a substrate. The best results are found when the alloy is disposed as a thin film with a thickness typically less than about 2500 Å. Electro-magnetic properties of the resulting EHE sensor can be made to vary by the composition of the alloy, its thickness, and its geometry on the planar surface. As such, much of this disclosure concerns the alloy itself and its deposition on a substrate. FIG. 2 shows the geometry of a magnetic alloy sample used for the measurement of extraordinary Hall effect voltage and resistance. A center or sense current wire 32 defines a sense current wire width 32 and a pair of pads labeled C1 and C2 that connect to a sense current source. Intersecting the sense current wire is a first Hall voltage wire 34 that defines a voltage wire width 36 and pads labeled H1 and H2.

Also intersecting the sense current wire is a second Hall voltage wire 38 that defines a voltage wire width 40 and pads labeled H3 and H4. EHE voltage is measured across either of the pairs of pads on opposing sides of the current wire, the pair H1-H2 or the pair H3-H4. During a measurement, only one pair of pads is used. The intersection between the sense current wire and either of the Hall voltage wires is the effective area of the field sensor 42. The field sensor 42 is depicted at FIG. 2 in an oval shape to preclude confusion with the proximal straight lines, but in actuality the field sensor is the exact intersection of the two wires. By reducing the intersection area, a more localized magnetic field can be measured. Two Hall voltage wires 34 and 38 are provided to measure resistance along the current wire along the section length 44 between them.

Two pads on the same side of the sense current wire, for example the pair H1-H3 or the pair H2-H4, to measure the resistance of the sample. The shape shown in FIG. 2 is primarily for experimental purposes to evaluate different alloys, different thickness and different temperatures. For EHE sensor applications, it is preferred to increase the ratio of sense current wire width 32 (W_{c}) to sense current wire length 46 (L_{c}). The larger the ratio W_{c}/L_{c}, for example, as the ratio W_{c}/L_{c}, approaches one, the larger the EHE Hall voltage (V_{H}) relative to the supply voltage (V). The ratio W_{c}/L_{c} can never exceed one as W_{c} can never exceed L_{c}. A large ratio of W_{c}/L_{c}, also reduces the power consumption of the EHE sensor.

The EHE effect is characterized by a parameter called Hall resistivity, expressed as:

ρ_{xy}=(V_{xy}/I)t=R₀H+4πRₛM [1]

wherein ρ_{xy} is the Hall resistivity

V_{xy} is the Hall voltage

I is the sense current

t is the thickness of the film

R₀ is the ordinary Hall coefficient

Rₛ, is the spontaneous EHE coefficient, and

M is the magnetization of a ferromagnetic solid of which an EHE sensor is made.

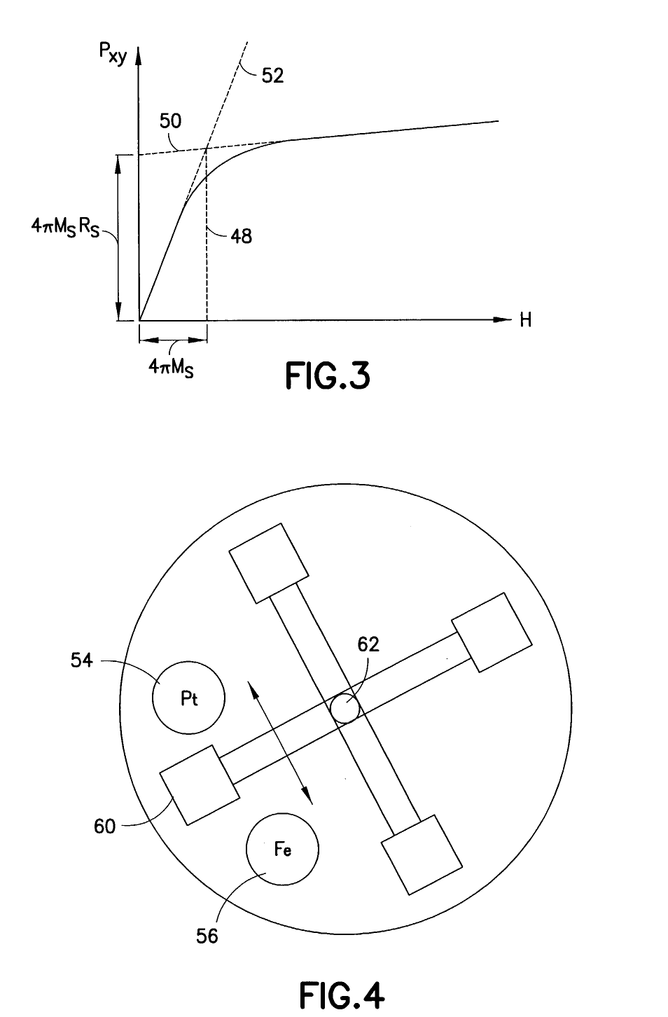

The first term (R₀H) in equation [1] represents the OHE, whereas the second term (4πRₛM) is due to EHE. The first term is generally several orders of magnitude smaller than the second in low field conditions, and can therefore be neglected. If the ferromagnetic thin film alloy has a magnetic anisotropy in the plane of the surface on which it is disposed, then the out-of-plane magnetization M increases linearly with perpendicular magnetic field H. This is true only until the out-of-plane magnetization reaches magnetic saturation Mₛ. Therefore the extraordinary Hall voltage is proportional to the magnetic field to be sensed, so long as M<Mₛ. FIG. 3 illustrates the field response of the Hall resistivity in a ferromagnetic solid and shows this linear relationship graphically. Dashed line 48 represents H=4πMₛ, beyond which linearity is no longer evident. Thus, EHE sensors are ideally suited to fields below H=4πMₛ. Dashed line 50 represents the asymptote of the high-field portion of the curve, which equals 4πRₛMₛ at H=0. Dashed line 52 is merely an extension of the linear portion of the low-field portion of the curve, the regime in which EHE sensors are most relevant. FIG. 3 demonstrates that above saturation, the Hall voltage is dominated by the slowly changing OHE. For this reason, the field dynamic range is up to the perpendicular saturation field of the ferromagnetic material used.

According to FIG. 3, a larger slope of ρ_{xy} vs. H would indicate a greater sensitivity of an EHE sensor. There are two ways to increase the slope of ρ_{xy}(H). First, select a ferromagnetic material with a large EHE, i.e., a large Rₛ. Since EHE is facilitated by enhanced electron spin-orbit coupling, this can be achieved by selecting materials that facilitate such enhanced coupling. Second, select a material that also has a small in-plane magnetic anisotropy, allowing an easy perpendicular magnetic saturation. In reality, these two selection criteria are intertwined in the sense that a material with a large Rₛ may not possess a low saturation field. Therefore, an efficient approach is to tune the composition of an alloy to reach a balance that maximizes the slope of ρ_{xy}(H). Striking such a balance is the essence of the present invention.

There are two spin-orbit scattering mechanisms involved in EHE, skew scattering and side-jump. Accordingly, the EHE coefficient Rₛ consists of two terms:

Rₛ=aρ+bρ² [2]

The first term (aρ), linear in longitudinal resistivity p, is due to skew scattering. The second term (bρ²), quadratic in ρ, is due to site-jump. Skew scattering generally dominates in dilute alloys at low temperatures. For samples with high impurity concentration and at high temperatures, the side-jump effect becomes more important. Therefore, the exponent dependence of Rₛ on ρ varies from 1 to 2 depending on which mechanism dominates.

To maximize Rₛ, equation [2] points to materials exhibiting a high resistivity ρ. Those are also materials that are rich in spin-orbit scatterings and loaded with disorders, as disclosed below. The composition of an alloy is varied to lower the saturation field and to maximize the EHE field sensitivity. Furthermore, research culminating in the present invention particularly concentrated on alloy samples wherein EHE is relatively insensitive to temperature in the area of 300 K. Such alloys could be used in EHE sensors for more cost effective manufacturing uses and other disparate applications. Temperature insensitivity is reflected by a low temperature coefficient.

Disorders in the alloy can be increased by several methods. Adding a buffer layer in the form of either a thin metallic layer such as Pt, or an insulating layer such as SiO₂ or Al₂O₃, either between the alloy and the substrate or overlying the alloy opposite the substrate, increases surface boundaries, and hence disorders. Adding another element to the alloy will also increase disorders, but may compromise other desirable properties. Rare earth elements, those defined by an atomic number between 58 and 71, inclusive, are rich in spin orbit scattering, and are therefore preferred. Generally, their composition within the alloy should be limited to about 20% in order not to denigrate other favorable properties of the alloy. With an alloy of the form R_{y}[MₓN₁₀₀₋ₓ]_{100-y} wherein 0<x<100, R represents the rare earth element and 0.00<y<20.00. These experiments concentrated on alloys wherein M was either Fe, Co, Ni, Fe_{z}Co_{100-z}, wherein 0<z<100. However, other magnetic transition alloys should perform similarly to those detailed herein. The remaining constituent of the alloy is N, which is selected from periods 5 and 6 of the periodic table of elements. The most promising candidates for the constituent N include Y, Zr, Nb, Mo, Tc, Ru, Rh, Pd, Hf, Ta, W, Re, Os, Ir, Au, In, Sn, Te, Tl, Pb and Bi.

### A Platinum-Based Ferromagnetic Alloy with Large EHE

A magnetron sputtering system shown in FIG. 4 was used to deposit EHE alloys in thin-film forms on well-polished glass substrates or silicon wafers. The substrates were cleaned in a vacuum using an ion beam. It was also observed that heating the substrate to between 200 and 500° C. better prepares the substrates to receive thin alloy films. Because the alloy film layers are very thin, quality of the initial seed layers is critical for uniform growth of the films at uniform thickness. The base vacuum was below 1×10-7 Torr before sputtering, and the Ar sputtering gas pressure was kept at 5 mTorr during sputtering. Sputtering rates were controlled at 1-3 Å/minute by using appropriate sputtering powers. Two sputtering guns were used, one loaded with a pure Pt target 54 and the other loaded with one of several pure ferromagnetic metal targets, wherein FIG. 4 depicts a pure Fe target 56. The ferromagnetic targets evaluated were Co, Fe, Ni, and FeₓCo₁₀₀₋ₓ, wherein 0<x<100. During deposition, the glass substrate 60 was rotated about a central axis 62 so that each substrate moved between the two sputtering guns. Alloys can be deposited on multiple substrates' by the arrangement of FIG. 4. The sputtering rates of the two targets were carefully calibrated and kept constant during the duration of sputtering. On each passage, the substrate was coated with a very thin amount of material (<0.1 nm, preferably 0.05 nm) in relatively quick succession such that even a monolayer did not have enough time to form. In this manner the layers from each pure source are combined into an alloy deposited on the substrate rather than distinct elemental layers. By varying and controlling the sputtering time above each gun, it is possible to achieve any desired alloy composition from 0 to 100%. After a particular alloy film was made with certain thickness, standard photolithography and lift-off were then used to pattern these films into a Hall sensor for measurement. It is noted that once the best composition for EHE is found, the above sputtering method allows an operator to choose to a single FeₓPt₁₀₀₋ₓ target for sputtering. This method of alternating sputtering is a cost-effect way to prepare samples of various compositions and thickness for evaluation and comparison. Once a particular alloy composition and thickness is selected, the apparatus of FIG. 4 can be used with a single sputtering gun using a target of the selected alloy to cost effectively deposit thin films of the alloy on a plurality of substrates.

Electrical transport properties were measured using a DC four-probe method in a magnetic field. Cautions were taken to eliminate measurement errors such as thermoelectric voltage and Hall-probe misalignment. A SQUID (super conducting quantum interference device) magnetometer was used to measure the magnetization of the films. Among FeₓPt₁₀₀₋ₓ, CoₓPt₁₀₀₋ₓNiₓPt₁₀₀₋ₓ, and (Fe₁₀Co₉₀)ₓPt₁₀₀₋ₓ evaluated in this research, FeₓPt₁₀₀₋ₓ system yields the best EHE results.

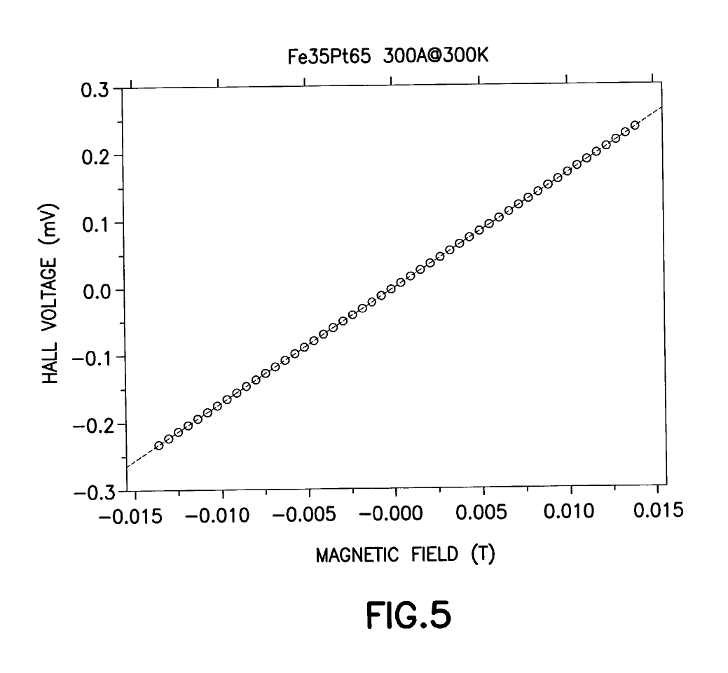

FIG. 5 shows the Hall voltage as a function of magnetic field measured at T=300 K for a 30 nm thick Fe₃₅Pt₆₅ film. The sensing electrical current is 5 mA. This result shows that the EHE is nearly perfectly linear in magnetic field. At zero magnetic field, the Hall voltage is zero, behaving like a sensitive null-detector.

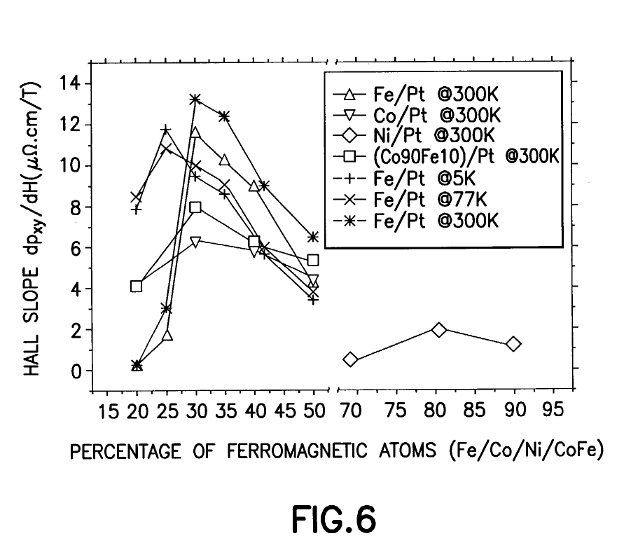

EHE properties as functions of composition and film thickness are graphed at FIG. 6, wherein the initial Hall slope, dρ_{xy}/dH=R_{H}, obtained near zero field, is plotted against atomic percent composition for alloys of FeₓPt₁₀₀₋ₓ, CoₓPt₁₀₀₋ₓ, NiₓPt₁₀₀₋ₓ, and (Fe₁₀Co₉₀)ₓPt₁₀₀₋ₓ at a temperature of 300 K, wherein x varies from 20% to 90%. As with all graphs herein, lines are drawn for the convenience of the viewer. Every sample in FIG. 6 has the same thickness of 30 nm for comparison. This graph shows that EHE has a peak within a composition range of 25-35% of an active magnetic component (Fe, Co, Fe₁₀Co₉₀), except for NiₓPt₁₀₀₋ₓ system where the peak occurs at x=80% and the peak EHE is not as large at those of other systems. Among all samples in FIG. 6, FeₓPt₁₀₀₋ₓ at x=30% has the largest EHE initial slope, 13.3 μΩ·cm/T at T=300 K and t=30 nm. The neighboring x=35% has the second largest slope at 12.4 μΩ·cm/T at T=300 K and t=30 nm.

The result in FIG. 6 shows a generic trend in the composition dependence of initial Hall slope. Near the lower composition region (left-hand side of the peak), the reduction in Hall slope is due to two factors: the reduced number of magnetic scatterers and the emergence of paramagnetism at 300 K. Paramagnetism is a phenomenon wherein the magnetic moments in a substance are randomly oriented and thermally fluctuating in the absence of a magnetic field. Paramagnetism is detrimental to EHE in that EHE requires ferromagnetic ordering. In the higher composition region (right-hand side of the peak), the decrease of the Hall slope is caused by the gradually larger perpendicular saturation field (Hₛ=4πMₛ) as magnetization increases with magnetic composition.

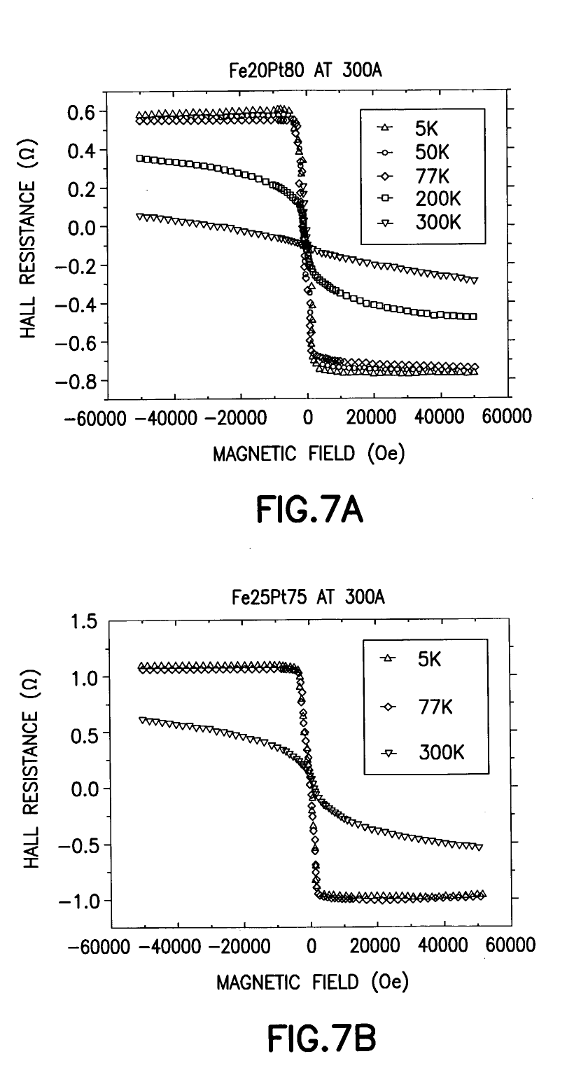

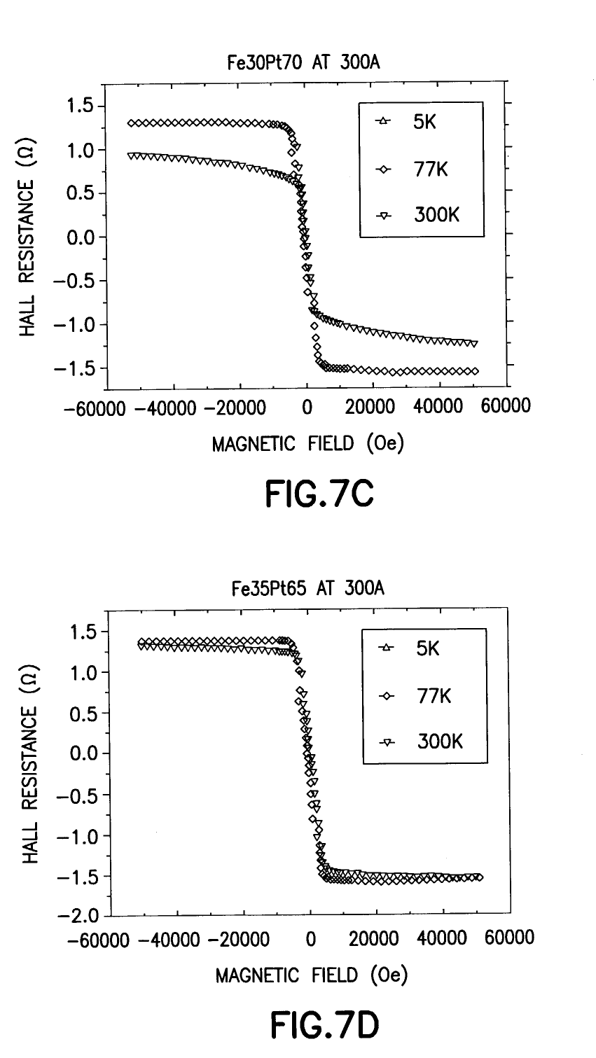

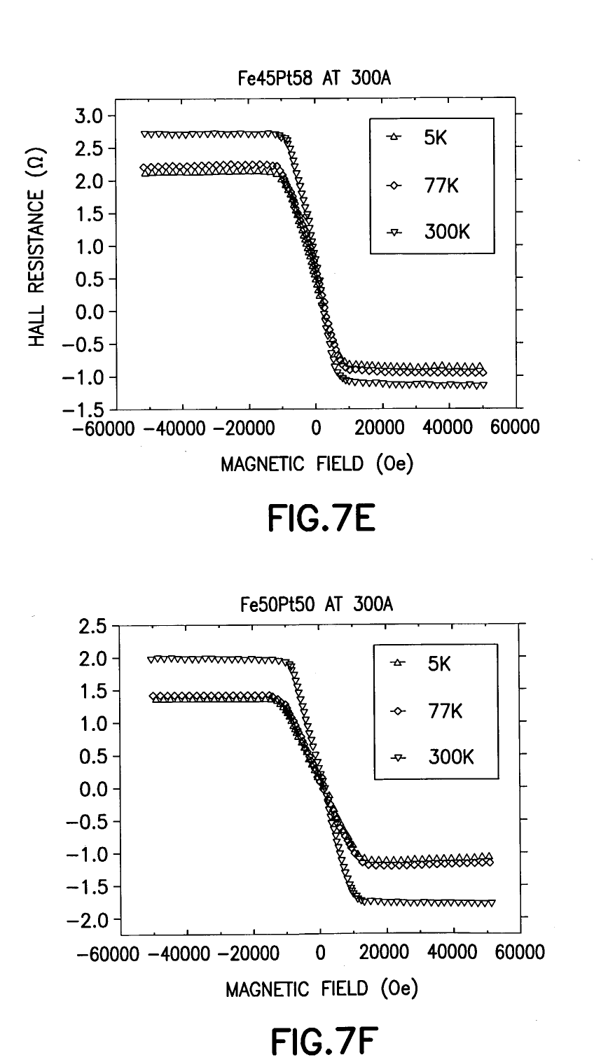

FIGS. 7A through 7F each show the Hall resistance vs. magnetic field curves measured at temperatures between 5 K and 300 K for one of six 30 nm thick FeₓPt₁₀₀₋ₓ films at x=20, 25, 30, 35, 42, and 50%. As the Fe composition increases, the perpendicular saturation field increases, which tends to reduce the initial Hall slope. At the low Fe compositions, the alloys remain ferromagnetic at temperatures at and below 77 K but become paramagnetic-like at 300 K, which decreases the initial Hall slope.

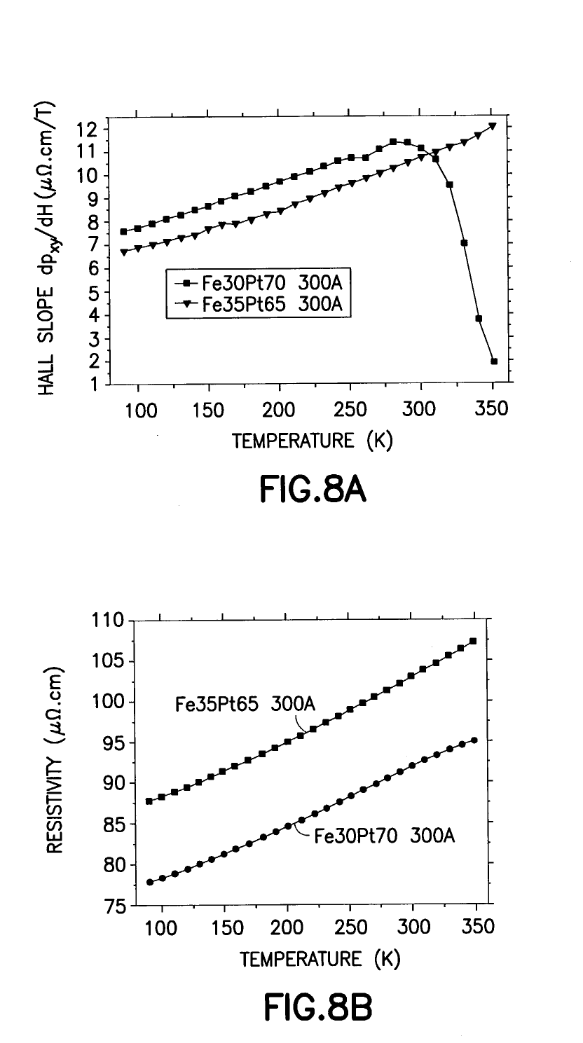

FIGS. 8A and 8B show the initial Hall slope and resistivity, respectively, plotted against temperature for two 30 nm thick FeₓPt₁₀₀₋ₓ films at x=30 and 35%. These alloy compositions were chosen because they exhibit the two highest Hall slopes. Lines are drawn for the convenience of the viewer. Both samples show steady increases of Hall slope as temperature is raised until about 300 K. While the x=35% sample maintains a linear relation between dρ_{xy}/dH and temperature, the x=30% sample discontinues its lower-temperature linearity beyond about 280 K. The drop in Hall slope is due to the emergence of paramagnetism, or loss of ferromagnetism. The resistivity of both samples increases with temperature, confirming the metallic natures of the samples. At 300 K, resistivity for each sample is larger than 90μΩ-cm, a very large value for a metallic alloy. The large resistivity also explains why the EHE is large in these samples, as EHE scales with increasing resistivity.

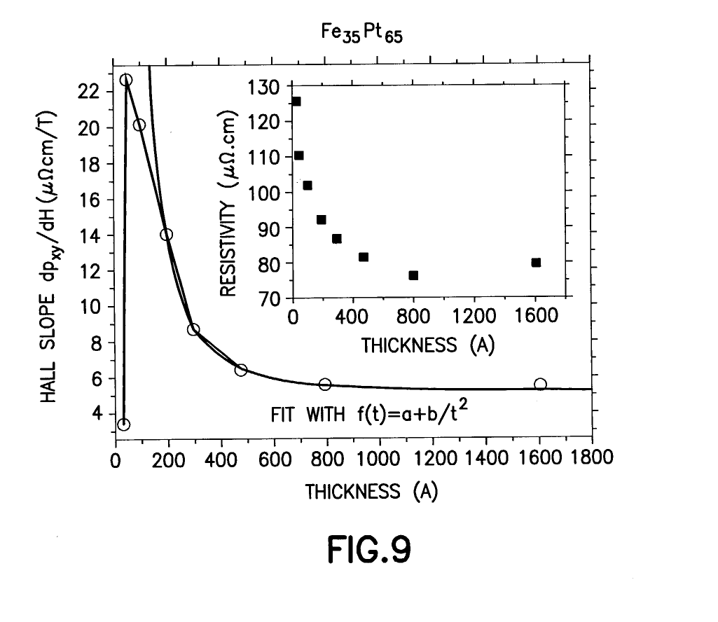

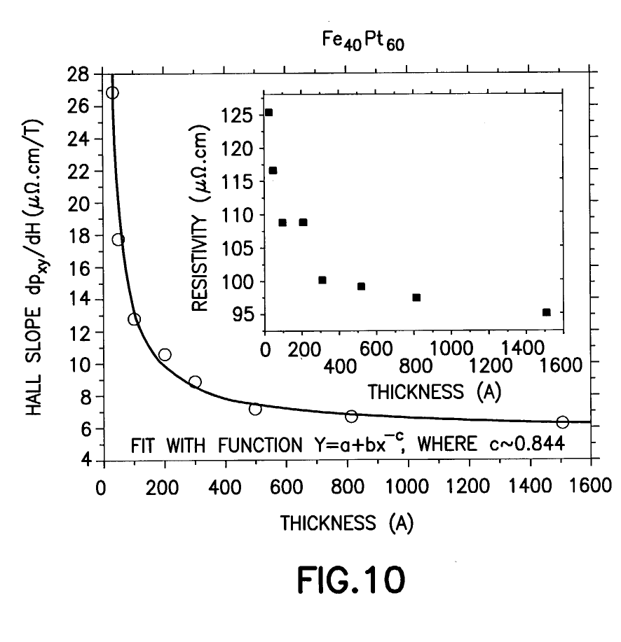

FIGS. 9 and 10 depict the effect of alloy film thickness on the EHE. Reduction in thickness increases Hall voltage, V_{xy}, in two ways. First, manipulating equation [1] yields V_{xy}=ρ_{xy}I/t. Since t is film thickness in the denominator, thinner films necessarily yield a larger Hall voltage. Second, thinner films tend to have greater resistivity due to enhanced geometrical scattering (ρ-ρ_{bulk}∝1/t). Greater geometrical scattering reduces the electron mean-free-path, giving rise to higher electrical resistivity. A larger resistivity in turn gives rise to a larger EHE resistivity, because ρ_{xy}∝ρ∝ρ_{bulk}+c/t (c is constant) for skew scattering and ρ_{xy}∝ρ²∝(ρ_{bulk}+c/t)² for side-jump scattering. Correspondingly, the Hall voltage could scale with thickness according to V_{xy}∝ρ_{bulk}/t+c/t² (skew) or ∝(ρ_{bulk}+c/t)²/t (sidejump). Under both scattering mechanisms, reducing thickness produces a significant increase in Hall voltages.

FIGS. 9 and 10 show the effect of thickness on Hall slope and resistivity of Fe₃₅Pt₆₅ and Fe₄₀Pt₆₀, respectively. In the thin film limit, resistivity for both series of samples increases due to enhanced contribution from surface scattering. At the same time, Hall slope increases substantially. In the Fe₃₅Pt₆₅ series, FIG. 9 shows that samples with very small thickness suffer a precipitous drop in Hall effect. This is because these very thin films cease to be ferromagnetic at 300 K, as will be shown next.

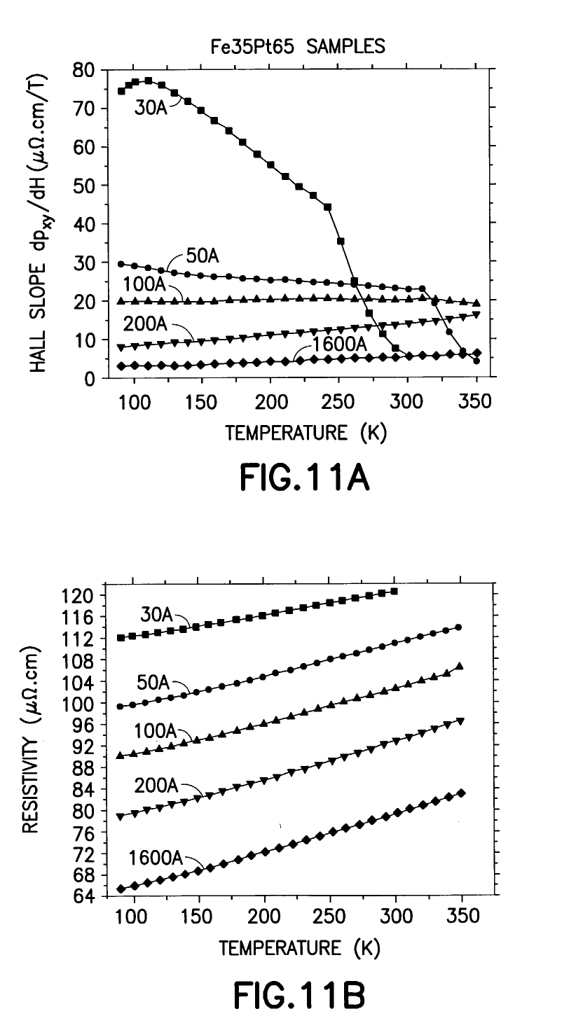

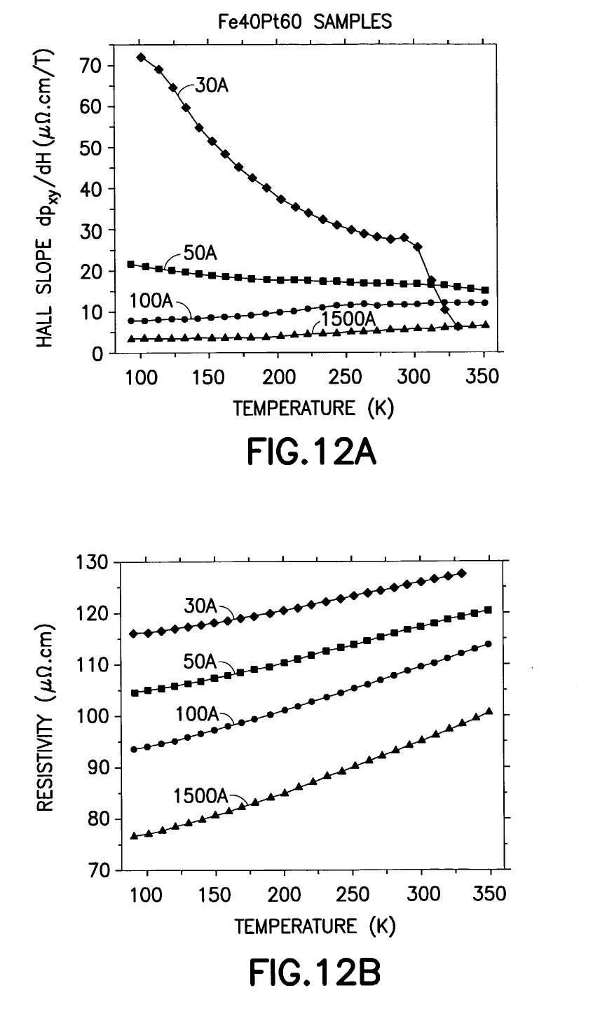

In general, magnetic sensors should work at room temperature T=300 K within a range of +/−50 K. Within this range, the temperature coefficient, or relative change in Hall slope per 1 K change in temperature, should be as small as possible. FIGS. 11A-11B and 12A-12B depict the temperature dependence of the Hall slope (11A and 12A) and resistivity (FIGS. 11B and 12B) for Fe₃₅Pt₆₅ and Fe₄₀Pt₆₀, respectively. This analysis discloses what composition and thickness yield the best combination of Hall sensitivity and thermal stability. Thickness ranges from 30 Å to 1600 Å as depicted on the graphs.

For the Fe₃₅Pt₆₅ series in FIGS. 11A-11B, the 30 Å thick sample has the largest slope of 78 μΩ·cm/T at T˜110 K, corresponding to sensitivity of 256 mV/mA·T. However, this sample is not ferromagnetic at room temperature, so its utility is limited. The 50 Å thick sample has a very large Hall slope of 22 μΩ·cm/T (sensitivity of 45 mV/mA·T) at T=300 K and a small temperature coefficient T.C.=−1.50×10⁻³ K⁻¹. However, the Hall slope versus temperature for this sample changes abruptly at about 320 K with the onset of paramagnetism, rendering the sample ineffective for near room temperature sensing. Finally, the 100 Å sample has a very large Hall slope of 20 μΩ·cm/T (sensitivity of 20 mV/mA·T) at T=300 K, and a small T.C.=3.35×10⁻⁴ K⁻¹, in the room temperature region. This particular film remains ferromagnetic at 350 K, the upper limit of measurement in this series of experiments. Therefore, in the Fe₃₅Pt₆₅ series, the 100 Å sample is a good candidate for a room temperature magnetic sensor.

Using similar analysis applied to the Fe₄₀Pt₆₀ series depicted in FIGS. 12A-12B, the good candidate for room temperature magnetic sensor is the 50 Å sample. This film has a very large Hall slope of 17.7 μΩ·cm/T at T=300 K, and a small T.C.=−7.27×10⁻⁴ K⁻¹ in the target temperature region. Its temperature coefficient of resistance is 5.80×10⁻⁴ K⁻¹. It remains ferromagnetic at 350 K, the upper limit of measurement for this series of experiments. Assuming a sensing current of 0.8 mA which corresponds to a current density of 1×10⁵ A/cm² in our sample, the Hall voltage sensitivity is 2.8 μV/G or 36 mV/mA·T. Such sensitivity is of the same order of magnitude as those of commercial semiconductor Hall sensors. Typically, commercial sensors have a sensitivity 1-100 μV/G, or 0.1-1000 mV/mA·T with a sensing current of 1-100 mA. As mentioned above, metal-based Hall sensors enjoy some major advantages over semiconductor Hall sensors.

For maximum field sensitivity, the 50 Å Fe₄₀Pt₆₀ appears better than the 100 Å Fe₃₅Pt₆₅. Since the former is thinner by a factor of two, its Hall voltage will be larger by approximately a factor of two. Conversely, thicker films can be expected to be more mechanically robust and stable over time, and more resistant to electromigration and oxidation. In light of those pragmatic concerns, the 100 Å Fe₃₅Pt₆₅ may have certain advantages over the 50 Å Fe₃₅Pt₆₅. To the knowledge of the inventors, the Hall slopes for both samples at room temperatures are the largest ever reported among magnetic alloys including transition metals and rare-earth elements.

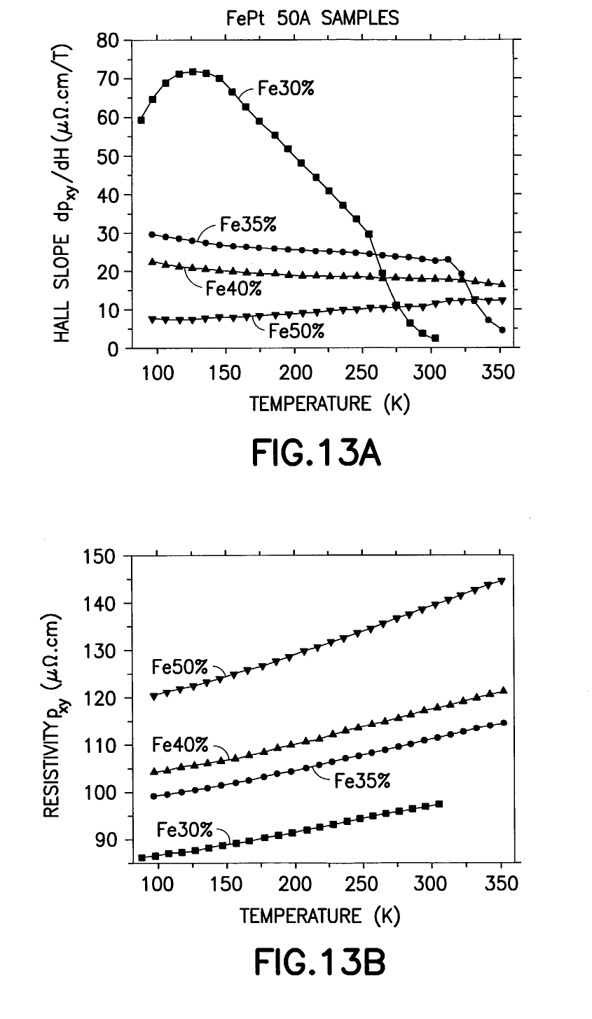

As a comparison to the data presented in FIGS. 11 and 12, the Hall slope and resistivity is plotted versus temperature in FIGS. 13A and 13B, respectively, for FeₓPt₁₀₀₋ₓ at a film thickness of 50 Å for x=30, 35, 40, 50%. This data confirms that x=35% and x=40% are optimum compositions for the alloy for use in an EHE sensor at room temperature.

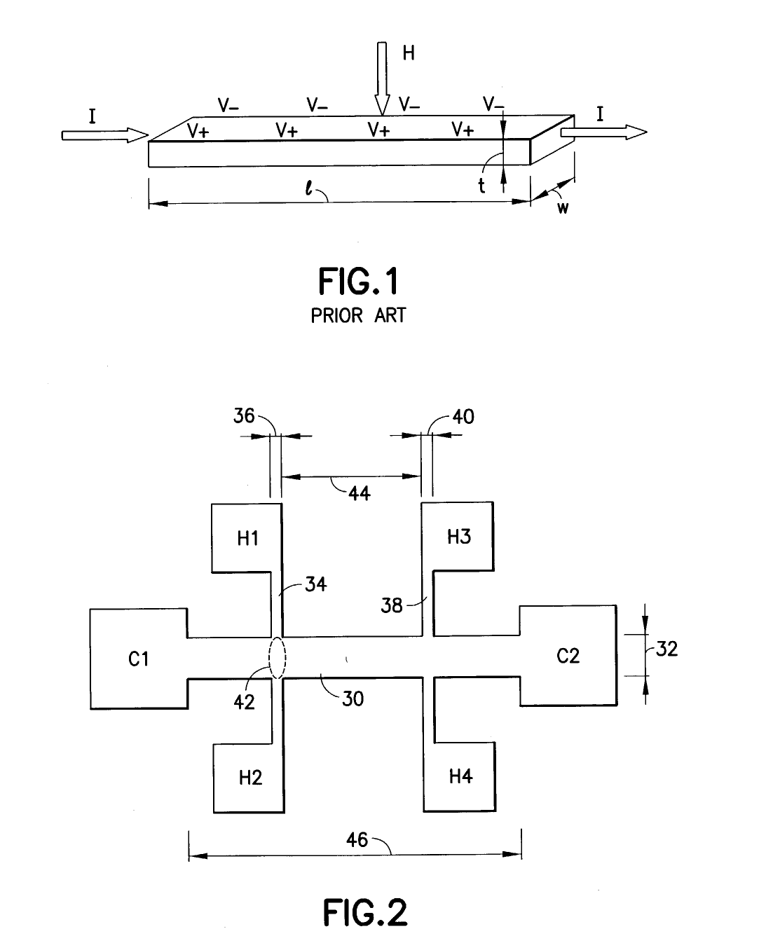

In general, it may be informative to keep constant the current density passing through the various alloy film samples for comparison purposes, i.e., I=iwt, where i is the current density through the cross-section of the alloy film sample, and w is the film width (similar to sense current wire width 32 in FIG. 1). Substituting the constant current density relationship above into equation [1] and taking the derivative with respect to H then yields:

dV_{xy}/dH=(dρ_{xy}/dH)iw=R_{H}iw [3]

wherein R_{H} is shorthand for the initial Hall slope dρ_{xy}/dH. In order to make a comparison among all sensors, the current density i and the sample width w remain unchanged, leaving the initial Hall slope dρ_{xy}/dH a good indicator of the sensitivities of the various film samples relative to one another. Most of the data presented herein is based on the initial Hall slopes.

Unlike comparing films of the present invention to one another, comparison with semiconductor Hall sensors cannot be performed under the same current density because normal semiconductor materials have very large resistivities. In order to compare with them, we should assume the same bias voltage is applied: Vₓₓ=IR and R=ρl/wt. Substituting into equation [3] yields:

dV_{xy}/dH=R_{H}I/t=(R_{H}/ρ)(w/l)Vₓₓ [4]

Therefore at a constant bias voltage Vₓₓ, the sensitivity of Hall sensors is proportional to an intrinsic factor RH/p and a dimension factor w/l. Assume two Hall sensors have the same active area shape and size (i.e. the same w & 1, or the same are for the field sensor 42 shown in FIG. 1), the sensitivity is simply proportional to the quantity RH/P, which is an indicator of how much bias voltage is converted into Hall voltage. This quantity is around 0.15T⁻¹ for the alloy film samples detailed herein, which compares very favorably with Si (0.13T⁻¹) and GaAs (0.66T⁻¹). In this sense, the EHE sensors described herein are just as sensitive as those most popular semiconductor Hall sensors. Note that at constant bias voltage, the sensitivity of a Hall sensor can be increased further by increasing the ratio w/l as noted above.

Aging Effect of EHE Sensors

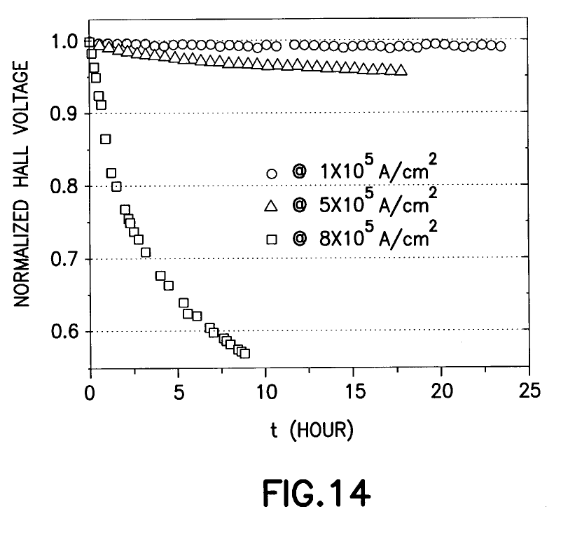

The extraordinary Hall voltage is proportional to sense current. Because the EHE sensors are rather thin, even a moderate sense current can translate into a large current density. Consequently, self Joule-heating or electromigration may cause the sensor to age at a rate faster than a particular application can tolerate. This aging effect of EHE sensors is evaluated herein by measuring the extraordinary Hall voltage versus time for a 50 nm-thick Fe₄₀Pt₆₀ sample under three different sense current densities, 1×10⁵, 5×10⁵, 8×10⁵ A/cm². This data is reproduced graphically at FIG. 14. The lowest current density graphed there is safe for operation of the EHE sensor. However, the largest current density reduces the lifetime of the sensor to only hours. The cause of this decay is hypothesized to be due to self-annealing under thermal stress. Annealing tends to reduce sample resistivity. Since EHE scales with resistivity, annealing also reduces EHE. Aging effect is a critical phenomenon to analyze in order to determine the maximum current density for a particular EHE sensor. To reduce the effective current density, one can use square waves or other waveforms of the otherwise unmodified sense current, and measure EHE voltage using a lock-in amplification technique. Converting an arcuate sinusoidal waveform into a square waveform reduces voltage and may shift the signal phase. Lock-in amplification first makes the weak signal periodic, if necessary. This periodic signal is then amplified and phase-detected relative to a modulating signal. The amplified signal is phase-shifted if necessary and put through a low-pass filter to reduce the noise that was amplified earlier with the incoming square wave signal.

### Intrinsic Noise of EHE Sensors

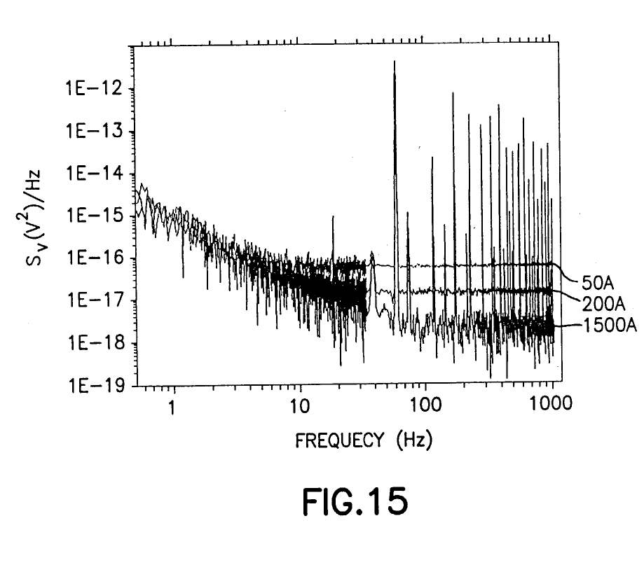

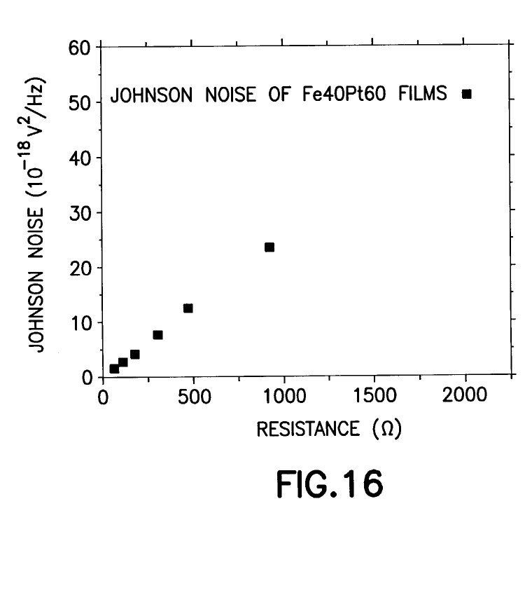

Electronic noise measurement was performed on several EHE alloy film samples of varying thickness. The results of the intrinsic noise are shown in FIG. 15 under no sense current. (Note the logarithmic scales in FIG. 15). Noise at lower frequencies is frequency-dependent, whereas noise at high frequency is frequency-independent (white noise or Johnson noise). The knee frequency separating the two regions occurs at about 40 Hz. As shown in FIG. 16, the Johnson noise or white noise component scales with resistance R of the film sample as expected, i.e., Sv=4kTR, wherein k is Boltzmann's constant and T is temperature in K.

One advantage of EHE sensors is that there is no current flowing between the two voltage leads (H1 and H2 of FIG. 1), hence no shot noise due to sense current. Also the bias voltage due to the sense current is applied perpendicular to the EHE voltage leads. Hence very little 1/f noise is created by the bias voltage, since 1/f noise is proportional to V². Therefore, only Johnson noise is the major source of electronic noise.

Using the resistivity measured and disclosed above, the effective resistance between the EHE voltage leads can be estimated. Taking the 50 Å-thick Fe₄₀Pt₆₀ alloy film as an example, Johnson noise between the EHE voltage leads is estimated to be about 1.13nV/sqr(Hz), which corresponds to a magnetic field noise of about 40nT/sqr(Hz), based on the field sensitivity of this sample,

(S_{H})^{1/2}=(S_{V})^{1/2}/(dV_{xy}/dH).

Under circumstances that a small sensor size is not critical, it is possible to decrease an EHE sensor's magnetic noise figure by increasing the physical size of a sensor. For example, keeping current density constant, the width of a Hall field sensor area (i.e. width of the sense current wire) can be widened to enable a higher total current, since current is proportional to the width. Johnson noise in the transverse direction increases as well, but only as square root of the width. Therefore by increasing the width of the Hall field sensor area, sensitivity of an EHE sensor increases faster than Johnson noise, leading to an overall reduction of magnetic noise.

### Broad Bandwidth of EHE Sensors

EHE sensors have advantages over semiconductor Hall sensors in the high frequency region. At high frequency, skin effect can be a major limiting factor of Hall sensors' application. The research surrounding this disclosure has found that skin effect can be minimized by reducing the ratio of thickness t to the depth of penetration δ=(ρ/πfμ)^{1/2} of the normal component of the electric field (wherein μ is permeability of the material).

It has been calculated that GaAs samples operating in several GHz must be about 10/m in thickness, which quite limits their usage in high frequency small sized applications. For example, if a Hall sensor is made with GaAs at a thickness of 1 μm to avoid the skin effect, its resistance will be over 26kΩ along the Hall sensor. Conversely, the 5 nm thick film of Fe₄₀Pt₆₀ alloy exhibits a resistance of around 1.9kΩ. Therefore, skin effects will have little influence on the EHE alloy films disclosed herein until very high frequency, due to the very thin film thickness. An estimate of the depth of penetration δ in copper is around 2.1 μm in 1 GHz field. An estimate of the depth of penetration δ in the 5 nm thick Fe₄₀Pt₆₀ alloy film in a 1 Ghz field is about 0.5 μm (with a relative permeability μ of 1000 assumed). For the skin effect to be appreciable in an EHE sensor with that alloy film would require a field as high as several THz.

### Shapes of EHE Sensors

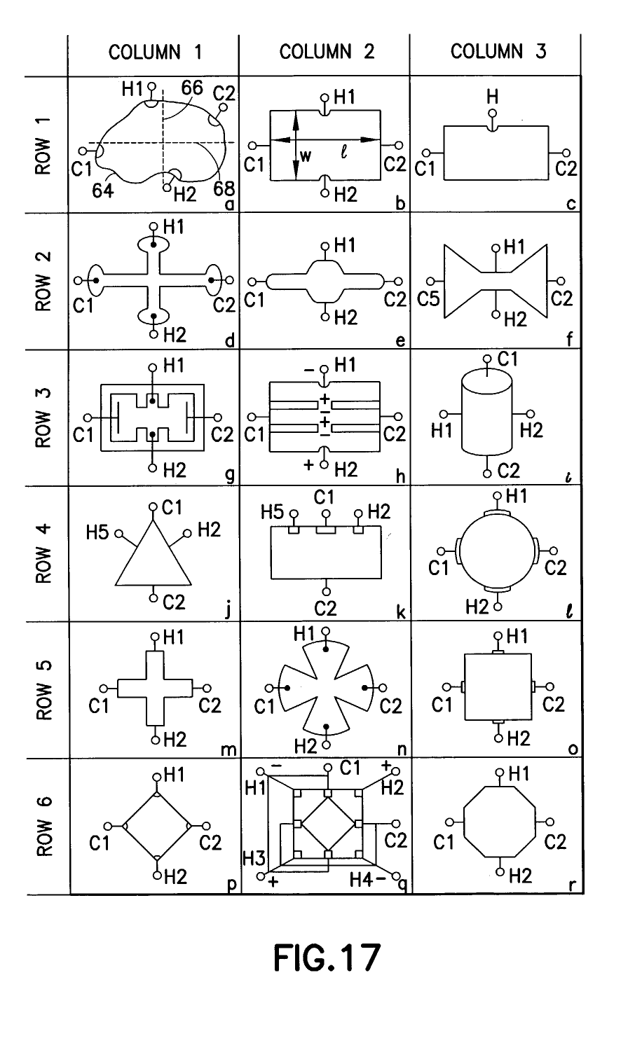

The geometric shape disclosed in FIG. 2 includes two Hall voltage wires, and for that reason is designed primarily for evaluating different alloys at different thickness. A variety of sensor shapes depicted in the Hall Sensor Handbook are depicted at FIG. 17, wherein each individual sensor design is designated by a row and column. For example, the sensor at the upper left corner of FIG. 17, row 1, column 1, defines an arcuate body that is not a standard geometrical shape. The body represents an alloy disposed on a substrate, and is bound by an alloy perimeter 64. The body is conceptually divided into areas of equal size by a first bisector 66, shown therein as a vertical dashed line. A first half of the body is one of the portions bounded by the first bisector and the alloy perimeter, and a second half is the remaining portion. In the example at row 1, column 1, point C1 lies within the first half and point C2 lies within the second half. Sense current is carried through the body between points C1 and C2, as explained above with reference to FIG. 1. The body is further conceptually divided into equal halves by a second bisector 68. A third half of the body is one of the portions bounded by the second bisector and the alloy perimeter, and a fourth half is the remaining portion. In this convention, the first and second half are exclusive of each other but not of the third and fourth halves, and the third and fourth half are exclusive of each other but not of the first and second halves. In the example at row 1, column 1, point H1 lies within the third half and point H2 lies within the fourth half. Hall voltage is measured across points H1 and H2, as explained above with reference to FIG. 1. The sensor at row 1, column 1, shows the point C1 lying within the quadrant defined by the first and third halves, C2 lying within the quadrant defined by the second and fourth halves, H1 lying within the quadrant defined by the second and third halves, and H2 lying within the quadrant defined by the first and fourth halves. In other sensor shapes, the points C1 and C2 lie along the second bisector. Examples are all the remaining sensors depicted in FIG. 17 except the sensor at row 6, column 2. Similarly, the points H1 and H2 may be disposed along the first bisector, examples being all sensors in column 1 except at rows 1 and 4; all sensors in column 2 except at rows 4 and 6; and all sensors in column 3 except at row 1. Alternatively, the points H1 and H2 may be disposed within the same third or fourth half, as in the sensors at column 1, row 4; and at column 2, rows 4 and 6.

As described above with reference to FIG. 1, the field sensor is that area where the sense current wire and the voltage wire intersect. This area may comprise the entire body defined by the alloy perimeter, as in the sensors at row 1, columns 1 and 2; and row 4, column 3, to name only three examples. Alternatively, the field sensor may comprise an area less than the entire alloy perimeter, as would be the case in the sensors at row 2, columns 1 and 2; and at row 5, columns 1 and 2, to name only four examples. While the physics behind EHE is completely different from that of OHE, any shape for ordinary Hall sensor will work for EHE sensors. Those illustrated in FIG. 17 are merely representative and not limiting with respect to the ensuing claims.

### Arrays of EHE Sensors

One or two-dimensional arrays of EHE sensors can be constructed to measure or image spatially varying magnetic fields. Such arrays can be used to make a magnetic camera in the same manner a charged-coupled device (CCD) camera. In comparison, it is more difficult and expensive to construct sensor arrays based on semiconductor Hall sensor, GMR, or MTJ sensors.

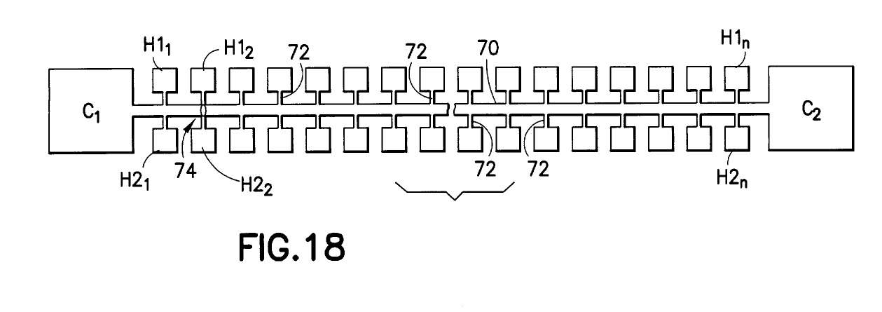

Serving only as one example, FIG. 18 shows a schematic of a one-dimensional array of extraordinary Hall effect sensors. Similar to FIG. 1, a sense current wire, known as a Hall bar 70 when deployed in an array, carries sense current between points C1 and C2 at opposing ends of the Hall bar. Crossing the Hall bar is a plurality of voltage wires 72, each terminating at opposing points H1ₙ and H2ₙ, wherein n is an integer representing the sequential number of the voltage wire along the Hall bar. Each intersection of the Hall bar with a voltage wire is the field sensor, whose area is the area of the intersection (a circle is depicted in FIG. 18 for illustration clarity). The array depicted at FIG. 18 therefore defines a plurality of n filed sensors. These field sensors can be monitored and measured simultaneously so that the spatial magnetic field along the Hall bar can be interpreted from the discrete data sensed by each field sensor. Additionally, this entire array can be scanned in another direction, preferably perpendicular to the Hall bar, to measure the spatial magnetic field over an entire two-dimensional surface.

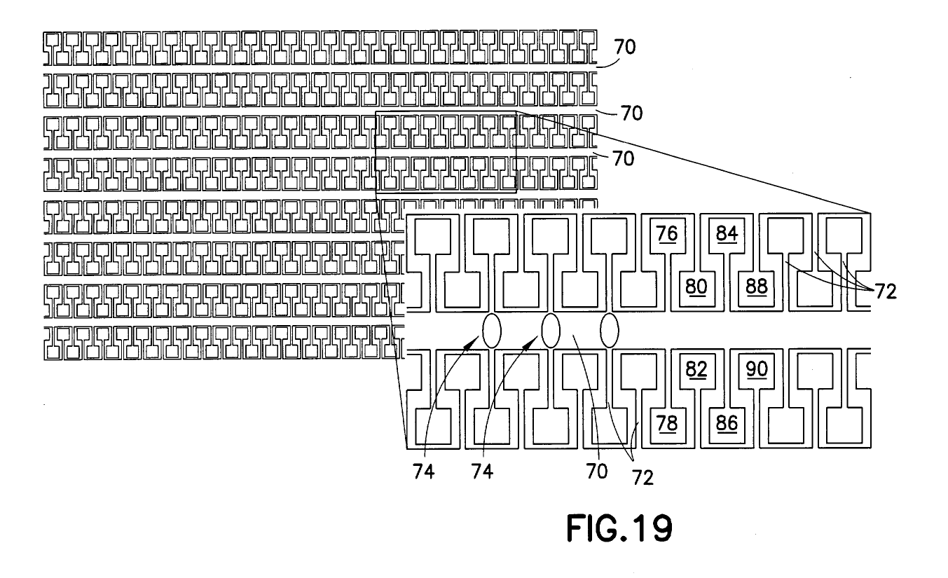

Serving only as one example, FIG. 19 shows the schematic of a two-dimensional array of extraordinary Hall effect sensors. This two-dimensional sensor array can be used to measure the two-dimensional spatial magnetic field across a surface simultaneously, as opposed to the time delay inherent in scanning the one-dimensional array of FIG. 18 across a surface. The array of FIG. 19 comprises a plurality of Hall bars 70 (points C1 and C2 not shown), each crossed by a plurality of voltage wires 72 defining at each of intersection a field sensor 74, similar to the one-dimensional array discussed previously.

Where each sequential Hall bar is represented by the integer m, and each sequential voltage wire along the m^{th} Hall bar is represented by the integer n, then each voltage wire includes opposing points H1_{m,n} and H2_{m,n} across which Hall voltage is sensed. A portion of the array in FIG. 19 is expanded to show the spatial relation of these various points or pads. Taking pad 76 to represent H1_{m,n} along Hall Bar m, then the opposing pad 78 represents H2_{m,n}. Immediately adjacent to H1_{m,n} is pad 80, which connects via its voltage wire to the next sequential Hall bar m+1 on the side of its own Hall bar corresponding to pad 78. Therefore, pad 80 is H2_{m+1,n}. Immediately adjacent to pad 78 is pad 82, which connects via its voltage wire to the sequentially previous Hall bar m−1 on the side of its own Hall bar corresponding to pad 76. Therefore, pad 82 is H1_{m-1,n}. Immediately adjacent to pad 80 is pad 84, which connects to Hall bar m on the side corresponding to pad 76, making pad 84 represent H1_{m,n+1}. Opposing pad 84 along the same voltage wire is pad 86, which is represented by H2_{m,n+1}. Pad 88 is connected to Hall bar m+1 and is designated H2_{m+1,n+1}. Pad 90 connects to the sequentially previous Hall bar m−1, and is designated H1_{m-1,n+1}. By this convention, every pad and field sensor can be identified by a subscript m, n.

The Hall bars and voltage wires, except the sensing areas and the vicinity of each sensing area, of both one-dimensional and two-dimensional arrays can be covered by highly conducting films, such as gold or copper, to reduce both the power consumption of the arrays and electronics noises from the non-sensing areas.

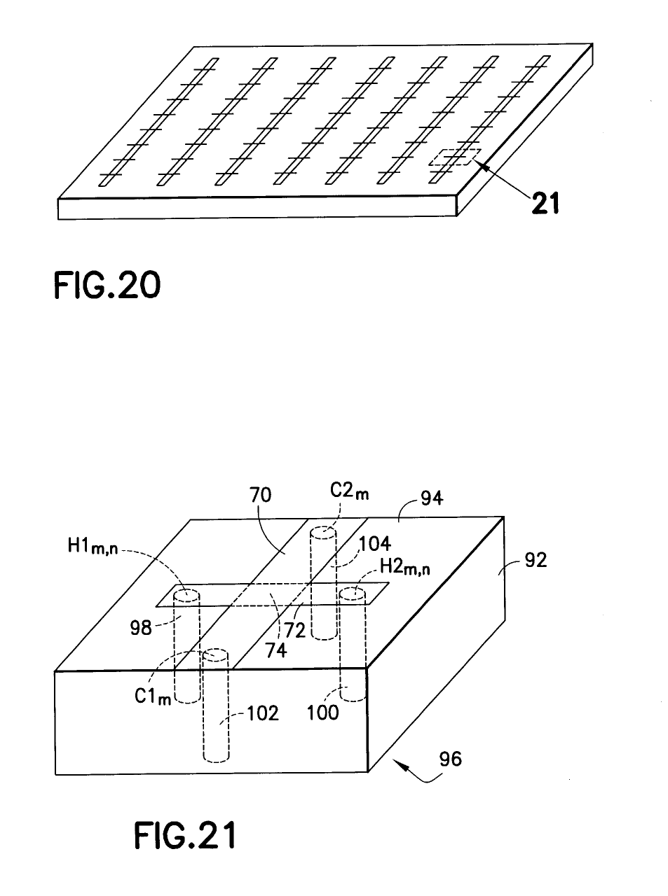

Another embodiment of a two-dimensional array of EHE sensors is shown in FIG. 20, wherein the alloy as previously described is disposed on a substrate such as polished glass or silicon. The novel features of this embodiment are evident in FIG. 21, which is merely an expanded portion of FIG. 20 detailing a single EHE sensor. The alloy is deployed to consitute a Hall bar 70 and a voltage wire 72, intersecting to define a field sensor 74 as described above with respect to FIG. 18. However, the embodiment of FIG. 20-21 includes a substrate 92, which may include a dielectric layer such as SiO₂, that defines first surface 94 upon which the alloy is disposed, an opposing second surface 96, and a plurality of vias extending between those surfaces. Each via is filled with a conductive material such as Cu or Au. At the first surface, the conductive material in the vias contacts a portion of the sensor so that electrical data may be collected at the second surface of the substrate.

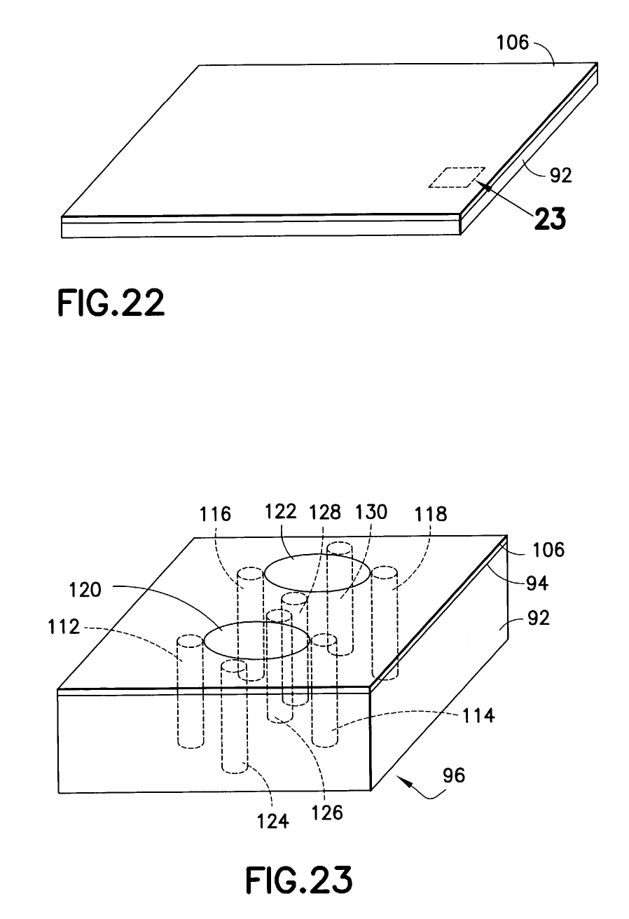

For example, the filled via designated 98 is an electrical lead from the point H1_{m,n}, and the filled via designated 100 is an electrical lead from the point H2_{m,n}, both of which are at opposing ends of the n^{th} Hall voltage wire that itself crosses the m^{th} Hall bar. The filled via designated 102 is an electrical lead from the point C1ₘ and the filled via designated 104 is an electrical lead from the point C2ₘ, both of which are along the m^{th} Hall bar. For illustration purposes, filled vias 102 and 104 are shown in the expanded view of FIG. 21 associated with a single field sensor. In practicality, vias in contact with the Hall bar would likely be located only at opposing ends of each Hall bar, rather than a pair of Hall bar vias associated with each sensor as FIG. 21 might otherwise suggest. Since the substrate or the dielectric layer is electrically insulating, current may be provided to the Hall bars by power strips, foils, etc., that extend along opposed ends of the substrate, as shown in FIG. 22 (designated 108 and 110).

The embodiment of FIGS. 20-21 represents a more efficient interconnect between the field sensors and other equipment that may manipulate the current and Hall voltages sensed by the field sensors into readable data. The filled vias concept will allow smaller line or wire widths and smaller field sensors since no surface area of the substrate first surface need be reserved for trace lines to carry data from the field sensors. It will also result in lower manufacturing costs for arrays of EHE sensors, since the vias should be much less cumbersome to fabricate than lithographing numerous additional trace lines into the alloy layer. The extensive work that has already been done in making vias in silicon integrated circuit chips is directly translatable to EHE sensors of the present invention. Vias are formed or otherwise imposed into the substrate, the vias are filled with gold or other conductive material, the surfaces of the substrate are then polished again and prepared for deposition of the alloy layer, the alloy layer is deposited as described above, and the alloy perimeter (to define Hall bars, Hall voltage wires, pads, etc.) is defined by etching or lithographing the alloy layer to form a plurality of sensors. This represents an extremely efficient method of making an array of EHE sensors.

Another embodiment of an array of EHE sensors is depicted at FIGS. 22-23, wherein FIG. 22 is generally similar to FIG. 20 but the Hall bars and Hall voltage wires are not visibly apparent. FIG. 23 is an expanded portion of FIG. 22 better illustrating filled vias through the substrate. In this embodiment, a distinct perimeter of Hall bars is not etched or lithographed from a blanket deposition of the alloy onto the substrate. The substrate 92 or the dielectric layer defines a first surface 94 on which an alloy layer 106 is disposed, and an opposing second surface 96.

A plurality of vias, of which the designators 112, 114, 116, and 118 are representative, are defined by the substrate and penetrate from the first surface to the second. The vias are filled with gold, copper, or any other conductive material, and the first surface of the substrate is polished and prepared to accept the alloy layer. The filled vias are spaced and arranged in matched pairs such that a line defined by each matched pair is preferably perpendicular to the direction of sense current I. Each field sensor, represented by the shaded areas 120 and 122, is the generalized area within the alloy layer that is between a pair of filled vias. For example and using the previous designations of m as an integer indicating row and n as an integer indicating position within a row, filled via 112 is arbitrarily chosen as H1ₘₙ. Filled via 114 becomes H2ₘₙ and the field sensor 120 is the area between them within the alloy layer. Hall voltage can be sensed at the field sensor through a matched pair of filled vias because sense current is imposed at each field sensor by a matched pair of current leads, similar to those described in reference to FIG. 21. For example, sense current flows through vias 124 and 126 through the field sensor 120. Hall voltage is measured at the field sensor 120 by use of the vias 112 and 114. Sense current is applied through vias 128 and 130 to the field sensor 122, and Hall voltage is measured by use of vias 116 and 118. Using the convention that rows of field sensors lie parallel to sense current direction, filled via 116 is H1ₘₙ₊₁ and filled via 118 is H2ₘₙ₊₁. The area between them within the confines of the alloy layer is the field sensor 122. This iteration can be repeated through the entire substrate so that field sensors according to this embodiment may be more densely packed than other embodiments. Additionally, the embodiment of FIGS. 22-23 is much more cost effective than others because it eliminates the need to lithograph the alloy layer. It is believed this embodiment is the most cost-effective method for making an array of EHE sensors.

While described in the context of presently preferred embodiments, those skilled in the art should appreciate that various modifications of and alterations to the foregoing embodiments can be made, and that all such modifications and alterations remain within the scope of this invention. Examples herein are stipulated as illustrative and not exhaustive.

What is claimed is:

1. An Extraordinary Hall Effect (EHE) magnetic sensor comprising:
an alloy of the form R_{y}[MₓN₁₀₀₋ₓ]_{100-y} wherein 0≦x≦100, 0.00<y≦20.00, and M is selected from the group consisting of Fe, Co, Ni, Fe_{z}Co_{100-z} wherein 0<z<100, and all magnetic alloys containing Fe, Co, or Ni.

2. The magnetic sensor of claim 1 wherein N is selected from the group consisting of Pt, Y, Zr, Nb, Mo, Tc, Ru, Rh, Pd, Hf, Ta, W, Re, Os, Ir, Au, In, Sn, Te, Ti, Pb and Bi.

3. The magnetic sensor of claim 2 wherein N is Pt.

4. The magnetic sensor of claim 3 wherein M is Fe.

5. The magnetic sensor of claim 4 wherein x≦⁴⁰.

6. The magnetic sensor of claim 5 wherein x=35.

7. The magnetic sensor of claim 6 wherein y<10.00.

8. The magnetic sensor of claim 1 wherein R is a rare earth element defined by one of the atomic numbers 58-71.

9. The magnetic sensor of claim 1 wherein the alloy exhibits a temperature coefficient T.C. having an absolute value |T.C.|≦0.003 K⁻¹ at least in the temperature range from 250 K to 350 K.

10. The magnetic sensor of claim 9 wherein the temperature range is from 273 K to 330 K.

11. The magnetic sensor of claim 1 wherein the alloy defines a sense current wire and two voltage wires, wherein each of the voltage wires are oriented perpendicular within 50 to the sense current wire.

12. The magnetic sensor of claim 11 wherein each of the wires terminate in a pad.

13. The magnetic sensor of claim 11 wherein the sense current wire carries sense current and EHE voltage is measured across at least one of the voltage wires.

14. The magnetic sensor of claim 1 wherein the alloy is disposed on a planar surface of a substrate, the alloy defines a sense current wire and a voltage wire that intersect one another at a field sensor, wherein the sense current wire defines a width wₛ along the planar surface immediately adjacent to the field sensing area, and the voltage wire defines a width wᵥ along the planar surface immediately adjacent to the field sensor, and wherein wₛ>wᵥ.

15. The magnetic sensor of claim 1 wherein the alloy defines a body across which sense current is carried between points C1 and C2, and Hall voltage is measured across points H1 and H2, wherein the body defines a first and an opposing second half divided from one another by a first bisector, and wherein C1 is located within the first half and C2 is located within the second half.

16. The magnetic sensor of claim 15 wherein the body further defines a third half and a fourth half divided from one another by a second bisector and wherein H1 is located within the third half and H2 is located within the fourth half

17. The magnetic sensor of claim 16 wherein H1 and H2 are located along the first bisector and C1 and C2 are located along the second bisector.

18. The magnetic sensor of claim 17 wherein the body is symmetrical about the first bisector.

19. The magnetic sensor of claim 18 wherein the body is symmetrical about the second bisector.

20. The magnetic sensor of claim 16 wherein a point H3 is located within the third half and spaced from H1; and further wherein resistance across a section of the alloy between C1 and C2 may be measured between H1 and H3.

21. The magnetic sensor of claim 20 wherein a point H4 is located within the fourth half and spaced from H2; and further wherein resistance of a section of the alloy may be measured between H2 and H4.

22. The magnetic sensor of claim 15 wherein H1, C1 and H2 are located within the first half

23. The magnetic sensor of claim 15 wherein a first line defined by C1 and C2 is perpendicular within 5° to a second line defined by H1 and H2.

24. The magnetic sensor of claim 1 wherein the alloy defines a thickness t such that 30 Å≦t≦1600 Å.

25. The magnetic sensor of claim 24 wherein 50 Å≦t≦800 Å.

26. The magnetic sensor of claim 25 wherein 100 Å≦t≦500 Å.

27. An array of n EHE magnetic sensors, n being an integer >1, comprising
an alloy R_{y}[MₓN₁₀₀₋ₓ]_{100-y}, wherein 0≦x≦100, 0.00<y≦20.00, and M is selected from the group consisting of Fe, Co, Ni, Fe_{z}Co_{100-z} wherein 0<z<100, and all magnetic alloys containing Fe, Co, or Ni;
the alloy formed into a Hall bar along which sense current is carried between points C1 and C2 located on the Hall bar;
a plurality of n voltage wires for measuring Hall voltage between points H1ₙ and H2ₙ which are located along the n^{th} voltage wire; and
a plurality of n field sensors defined by an intersection of the n^{th} voltage wire with the Hall bar.

28. The array of claim 27 further comprising a plurality of m Hall bars, m being an integer >1.

29. The array of claim 27 further comprising
an electrically non-conductive substrate defining a first and an opposing second surface and defining a plurality of non-intersecting vias penetrating from the first to the second surface, the alloy being connected to the first surface, wherein a via is aligned with each of the points C1, C2, H1ₙ and H2ₙ; and
a conductive material disposed and substantially filling the vias.

30. The array of claim 27 manufactured using photolithography to define a perimeter of the alloy.

31. The array of claim 27 manufactured using electron beam lithography to define a perimeter of the alloy.

32. An Extraordinary Hall Effect (EHE) magnetic sensor comprising:
an alloy R_{y}[MₓN₁₀₀₋ₓ]_{100-y} wherein 0≦x≦100, 0.00≦y≦20.00, the alloy defining a thickness t,
whereby M is selected from the group consisting of Fe, Co, Ni, Fe_{z}Co_{100-z} wherein 0<z<100, and all magnetic alloys containing Fe, Co, or Ni;
wherein N is selected from the group consisting of Pt, Y, Zr, Nb, Mo, Tc, Ru, Rh, Pd, Hf, Ta, W, Re, Os, Ir, Au, In, Sn, Te, TI, Pb and Bi;
wherein R is a rare earth element if y>0.00, and
wherein the alloy exhibits a temperature coefficient T.C. having an absolute value |T.C.|≦0.003 K⁻¹ at least in the temperature range from 273 K to 350 K.

33. The magnetic sensor of claim 32 wherein a current density i is passed through the sensor such that 10,000 A/cm²≦i≦800,000 A/cm².

34. The magnetic sensor of claim 33 wherein i≦500,000 A/cm².

35. The magnetic sensor of claim 34 wherein 50,000 A/cm²≦i≦150,000 A/cm².

36. The magnetic sensor of claim 32 further comprising a buffer layer coupled to the alloy, and a substrate defining a planar surface that is coupled to the alloy, wherein the buffer layer increases magnetic anisotropy perpendicular to the planar surface, the increase being relative to an identical sensor lacking the buffer layer.

37. The magnetic sensor of claim 36 wherein the alloy is disposed between the buffer layer and the planar surface.

38. The magnetic sensor of claim 36 wherein the buffer layer is selected from the group SiO₂, Al₂O₃, and Pt.

39. The magnetic sensor of claim 32 further comprising
a substrate defining a planar surface to which the alloy is coupled,
the alloy defining a sense current wire and a voltage wire that intersect one another at a field sensor, wherein the sense current wire defines a width wₛ along the planar surface immediately adjacent to the field sensing area, and the voltage wire defines a width wᵥ along the planar surface immediately adjacent to the field sensor, and wherein wₛ>wᵥ.

40. A method of making an EHE sensor comprising:
providing a substrate;
preparing the substrate by cleaning it in a vacuum using an ion beam;
selecting an alloy R_{y}[MₓN₁₀₀₋ₓ]_{100-y} wherein 0≦x≦100, 0.00<y≦20.00, M is selected from the group consisting of Fe, Co, Ni, Fe_{z}Co_{100-z} wherein 0<z<100, and all magnetic alloys containing Fe, Co, or Ni, wherein N is selected from the group consisting of Pt, Y, Zr, Nb, Mo, Tc, Ru, Rh, Pd, Hf, Ta, W, Re, Os, Ir, Au, In, Sn, Te, TI, Pb and Bi, and wherein R is a rare earth element defined by one of the atomic numbers 58-71 if y>0.00;
selecting a thickness t for the alloy; and
disposing the alloy onto the substrate at a thickness t.

41. The method of claim 40 further comprising: purposefully introducing disorders into the alloy to increase EHE.

42. The method of claim 41 wherein purposefully introducing disorders includes exposing the alloy to radiation.

43. The method of claim 40 wherein preparing the substrate includes heating the substrate to a minimum temperature of 500° C.

44. A method of designing an EHE sensor comprising:
selecting a first alloy R_{y}[MₓN₁₀₀₋ₓ]_{100-y} wherein 0≦x≦100, 0.00≦y≦20.00, M is selected from the group consisting of Fe, Co, Ni, Fe_{z}Co_{100-z} wherein 0<z<100, and all magnetic alloys containing Fe, Co or Ni, wherein N is selected from the group consisting of Pt, Y, Zr, Nb, Mo, Tc, Ru, Rh, Pd, Hf, Ta, W, Re, Os, Ir, Au, In, Sn, Te, Tl, Pb and Bi, and wherein R is a rare earth element defined by one of the atomic numbers 58-71 if y>0.00;
preparing a first and a second sensor sample wherein the first alloy is deposited at a first and a second thickness, respectively;
selecting a second alloy that varies from the first in either only the relative concentration of R or only the relative concentration of M;
preparing a third and a fourth sensor sample wherein the second alloy is deposited at the first and the second thickness, respectively; and
comparing electrical and magnetic properties of at least two of the sensor samples at a selected temperature.

45. The method of claim 44 wherein comparing electrical and magnetic properties includes comparing the temperature coefficients of at least two of the sensor samples.

46. The method of claim 44 wherein comparing electrical and magnetic properties includes comparing the magnetic saturation field of at least two of the sensor samples.

47. A method of determining a maximum acceptable sense current in an EHE sample sensor comprising:
selecting an alloy R_{y}[MₓN₁₀₀₋ₓ]_{100-y} wherein 0≦x≦100, 0.00≦y≦20.00, M is selected from the group consisting of Fe, Co, Ni, Fe_{z}Co_{100-z} wherein 0<z<100, and all magnetic alloys containing Fe, Co or Ni, wherein N is selected from the group consisting of Pt, Y, Zr, Nb, Mo, Tc, Ru, Rh, Pd, Hf, Ta, W, Re, Os, Ir, Au, In, Sn, Te, Tl, Pb and Bi, and wherein R is a rare earth element defined by one of the atomic numbers 58-71 if y>0.00;
preparing a sample sensor by disposing the alloy on a substrate surface such that the alloy defines a thickness t;
passing a first current through the alloy; measuring a first Hall voltage across the sample sensor at a first time;
measuring a second Hall voltage across the sample sensor at a second time;
passing a second current through the alloy;
measuring a third Hall voltage across the sample sensor at a third time;
measuring a fourth Hall voltage across the sample sensor at a fourth time; and
evaluating voltage as a function of time for the first and the second currents.

48. A method to reduce Joule heating on an EHE sensor comprising:
converting a first electrical current defined by an arcuate sinusoidal wave function into a second electrical current defined by a non-arcuate wave function; and
passing the second electrical current through the EHE sensor.

49. The method of claim 48 wherein the non-arcuate wave function is a square wave function.

50. The method of claim 48 further comprising: using lock-in amplification to facilitate measurement of Hall voltage across the sensor.

51. A method of making an array of EHE sensors comprising:
providing a substrate that defines a first surface, an opposing second surface, and a plurality of vias penetrating from the first surface to the second surface;
filling the vias with a conductive material;
polishing at least the first surface of the substrate; and
disposing an alloy layer that exhibits EHE onto the first surface.

52. The method of claim 51 further comprising: defining an alloy layer perimeter along the first surface, wherein the perimeter defines at least one Hall bar and a plurality of Hall voltage wires.

53. The method of claim 52 wherein defining an alloy layer perimeter includes using photolithography.

54. The method of claim 52 wherein defining an alloy layer perimeter includes using electron beam lithography.

55. A method of co-depositing two targets M and N onto a substrate comprising:
loading a first target M onto a first sputtering gun and loading a second target N onto a second sputtering gun;
mounting a discharge end of the first sputtering gun in spaced relation from a discharge end of the second sputtering gun within a vacuum chamber;
passing the substrate over the discharge end of the first sputtering gun for a first time interval so as to deposit a layer of the first target M at a thickness t₁ onto the substrate;
passing the substrate over the discharge end of the second sputtering gun for a second time interval so as to deposit a layer of the second target N at a thickness t₂ onto the substrate; wherein the start of the second time interval is within one minute of the end of the first time interval.

56. The method of claim 55 wherein t₁=t₂.

57. The method of claim 56 wherein ti<1 Å.

58. The method of claim 57 wherein t₁=0.5 Å.

59. The method of claim 55 wherein the first time interval and the second time interval are varied so that the alloy is not M₅₀N₅₀.

60. The method of claim 59 wherein a sputtering rate of the first sputtering gun and a sputtering rate of the second sputtering gun are varied so that the alloy is not M₅₀N₅₀.

61. A method of depositing an alloy film at a thickness t onto a plurality of substrates comprising:
mounting a discharge end of a sputtering gun in a vacuum chamber;
loading a target of the alloy onto a sputtering gun;
mounting a first substrate at a first location spaced from a central pivot;
mounting a second substrate at a second location spaced from the central pivot;
moving the first substrate about the central pivot into alignment with the discharge end of the sputtering gun and a layer of alloy at a thickness tₓ is deposited thereon;
subsequently moving the second substrate about the central pivot into alignment with the discharge end of the sputtering gun and a layer of alloy at a thickness tₓ is deposited thereon.

62. The method of claim 61 wherein the first and the second substrate are moved into alignment with the discharge end in alternating fashion so that n layers of alloy are deposited on the first substrate, wherein n is an integer >1 and ntₓ=t.
